(19) United States
(12) Patent Application Publication
(10) Pub. No.: US 2012/0062517 A1
(43) Pub. Date: Mar. 15, 2012

(54) OPTICAL TOUCH CONTROL APPARATUS AND TOUCH SENSING METHOD THEREOF

(75) Inventors: Hung-Ching Lai, Hsinchu (TW); Wu-Chieh Liu, Hsinchu (TW); Hui-Hsuan Chen, Hsinchu (TW)

(73) Assignee: PixArt Imaging Inc., Hsinchu (TW)

(21) Appl. No.: 13/018,972

(22) Filed: Feb. 1, 2011

(30) Foreign Application Priority Data
Sep. 13, 2010 (TW) 099130918

(51) Int. Cl. G06F 3/042

(52) U.S. Cl. 345/175; 178/18.09

(57) ABSTRACT

An optical touch control apparatus and a touch sensing method thereof are provided. The optical touch control apparatus comprises a light source supply module, an image sensing apparatus and a processing circuit. The light source supply module is used for supplying a light source to illuminate an object located on a plane. The image sensing apparatus is used for detecting the light of the light source reflected by the surface of the object to acquire an image. The processing circuit receives the image and calculates the object position related to the plane according to the image features of the object image in the received image and the imaging position of the object on the image sensing apparatus.

### FIELD OF THE INVENTION

The present invention generally relates to technologies in touch control field, and more particularly to an optical touch control apparatus and a touch sensing method thereof.

### BACKGROUND OF THE INVENTION

FIG. 1 is a perspective schematic view in accordance with a conventional optical touch control apparatus. Referring to FIG. 1, the optical touch control apparatus 100 is used for sensing a position of an object 102. The optical control apparatus 100 includes image sensing apparatuses 106 and 108 and a processing circuit 110, further includes reflectors 112, 114 and 116. The optical touch apparatus 100 is used cooperating with a panel 104. The panel 104 is used for providing a plane. The two image sensing apparatuses 106 and 108 and the three reflectors 112, 114 and 116 are located on the plane. In addition, a quadrilateral (such as a rectangle) labeled with 118 is a sensing area of the optical touch control apparatus 100.

The processing circuit 110 is electronically coupled with the image sensing apparatuses 106 and 108, for acquiring a position of the object 102 according to the images sensed by the two image sensing apparatuses 106 and 108. For detailed sensing principle of the optical touch control apparatus 100 and detailed method for calculating the position of an object, please refer to the description in Taiwan patent No.097126033. Here we will not go further on this point.

FIG. 2 is a schematic view of a conventional optical touch control apparatus 100 with single touch. In FIGS. 1 and 2, the objects with an uniform label represent one same element. In FIG. 2, the image sensing apparatus 106 can sense the object 102 along the sensing path 202, and the image sensing apparatus 108 can sense the object 102 along the sensing path 204. Thus, the coordinate of the object 102 can be acquired as long as the processing circuit 110 can calculates the intersecting point of the sensing paths 202 and 204.

However, the optical touch control apparatus 100 provides a background light source through reflectors, so that the above two sensing paths can be acquired by calculating a shading position of the object 102 in the background light source. Thus, the size of the optical touch control apparatus 100 would be limited by the size of the reflectors. Additionally, the optical touch control apparatus 100 has three reflectors disposed on the panel 104; therefore, the optical touch control apparatus 100 is easy to misjudge the position of the object 102 because of institution's flatness or bending. In another conventional optical touch control apparatus, a light guide element is used to replace with the above reflectors. It can be understood that, the optical touch control apparatus of this kind has the same problem.

### SUMMARY OF THE INVENTION

The invention is directed to provide an optical touch control apparatus without background light source, which can avoid misjudging the position of the object because of institution's flatness or bending.

The present invention is also directed to provide a sensing method of the above optical touch control apparatus. In one aspect, he optical touch control apparatus includes a first light source supply module, a first image sensing apparatus and a processing circuit. The first light source supply module is used for supplying a first light source to illuminate an object located on a plane. The first image sensing apparatus is disposed in a first corner of the plane, and is used for detecting the light of the first light source reflected by the surface of the object to acquire a first image. The processing circuit receives the first image and calculates the object position related to the plane according to the image features of the light of the first light source reflected by the surface of the object in the acquired first image and the imaging position of the object image related to the first image sensing apparatus. In an embodiment of the optical touch control apparatus, the optical touch control apparatus further includes a second image sensing apparatus. The second image sensing apparatus is disposed in a second corner of the plane, and is used for detecting the light of the first light source reflected by the surface of the object to acquire a second image. The processing circuit receives the second image and calculates the object position related to the plane according to the image features of the light of the first light source reflected by the surface of the object in the acquired first image, the image features of the light of the first light source reflected by the surface of the object in the acquired second image, and the imaging position of the object image related to the second image sensing apparatus. In an embodiment of the optical touch control apparatus, the optical touch control apparatus further includes a second light source supply module. The second light source supply module is used for supplying a second light source to illuminate the object located on above plane. In an embodiment of the optical touch control apparatus, the first light source supply module comprises a first laser light source and a first optical element. The first laser light source is used for providing a first line light source. The first optical element is used for converting the first line light source into the first light source for illuminating the plane. The second light source supply module comprises a second laser light source and a second optical element. The second laser light source is used for providing a second line light source. The second optical element is used for converting the second line light source into the second light source for illuminating the plane. In an embodiment of the optical touch control apparatus, the first optical element comprises a first cylindrical lens or a first MEMS scanning mirror. The first cylindrical lens is used for converting the first line light source into a first plane light source as the first light source for illuminating the plane. The first MEMS scanning mirror is used for changing the light direction of the first line light source to form the first light source, so as to scan the plane through the first light source. The second optical element comprises a second cylindrical lens or a second MEMS scanning mirror. The second cylindrical lens is used for converting the second line light source into a second plane light source as the second light source for illuminating the plane. The second MEMS scanning mirror is used for changing the light direction of the second line light source to form the second light source, so as to scan the plane through the second light source. In an embodiment of the optical touch control apparatus, the plane is shaped as a parallelogram. In another aspect, a touch sensing method is also provided. The touch sensing method is used for an optical touch control apparatus. The optical touch control apparatus includes a light source supply module and a first image sensing apparatus. The light source supply module is used for supplying a light source to illuminate an object located on a plane. The first image sensing apparatus is disposed in a first corner of the plane, and is used for detecting the light of the light source reflected by the surface of the object to acquire a first image. The method comprising steps of acquiring image features of the light of the first light source reflected by the surface of the object in the first image; calculating an imaging position of the object related to the first image sensing apparatus; and calculating the object position related to the plane according to above image features and the imaging position. In an embodiment of the touch sensing method, the image features comprise at least one of the brightness and the imaging size of the object image. In an embodiment of the touch sensing method, the optical touch control apparatus further includes a second image sensing apparatus. The second image sensing apparatus is disposed in a second corner of the plane, and is used for detecting the light of the light source reflected by the surface of the object to acquire a second image. The method further comprises steps of acquiring image features of the light of the light source reflected by the surface of the object in the second image; calculating an imaging position of the object related to the second image sensing apparatus; and calculating the object position related to the plane according to above image features and the imaging positions respectively related to the first image and second image.

The present invention uses a light source supply module, an image sensing apparatus and a processing circuit in an optical touch control apparatus. The light source supply module is used for supplying a light source to illuminate an object located on a plane. The image sensing apparatus is disposed at one corner of the plane, and is used for detecting the light of the light source reflected by the surface of the object to acquire an image. The processing circuit receives the image and calculates the object position related to the plane according to the image features of the object image in the acquired image and the imaging position of the object image related to the image sensing apparatus. Thus, the optical touch control apparatus calculates the object position related to the plane only according to the reflective brightness of the object and the imaging position of the object image related to the image sensing apparatus, but without use of a background light source. Furthermore, the present invention doesn't need any reflector, light emitting element or light guide element for providing a background light source, thus, misjudging the position of the object because of institution's flatness or bending can be avoided. For above and another objectives, features, and advantages of the present invention being better understood and legibly, accompanying embodiments together with the drawings are particularized.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1 is a perspective schematic view in accordance with a conventional optical touch control apparatus;

FIG. 2 is a schematic view of the conventional optical touch control apparatus with single touch;

FIG. 3 is a top view of the optical touch control apparatus in accordance with a preferred embodiment of the present invention;

FIG. 4 is a top view of the optical touch control apparatus in accordance with another preferred embodiment of the present invention;

FIG. 5 is a top view of the optical touch control apparatus in accordance with a third preferred embodiment of the present invention;

FIG. 6 is a processing diagram of the touch sensing method in accordance with a preferred embodiment of the present invention.

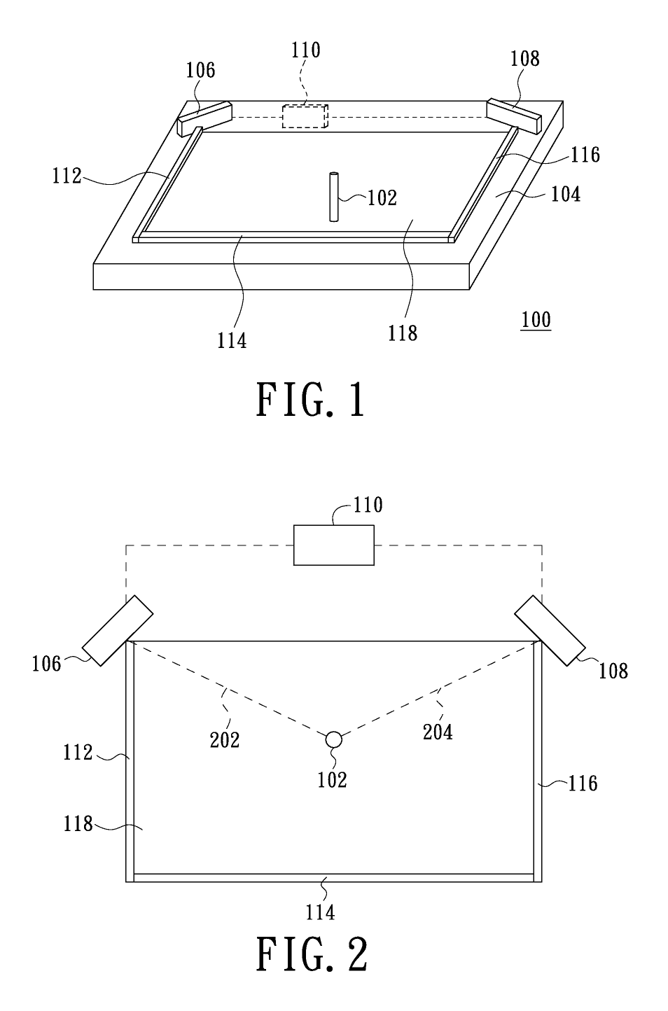

### DETAILED DESCRIPTION OF PREFERRED EMBODIMENTS

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

### A First Embodiment

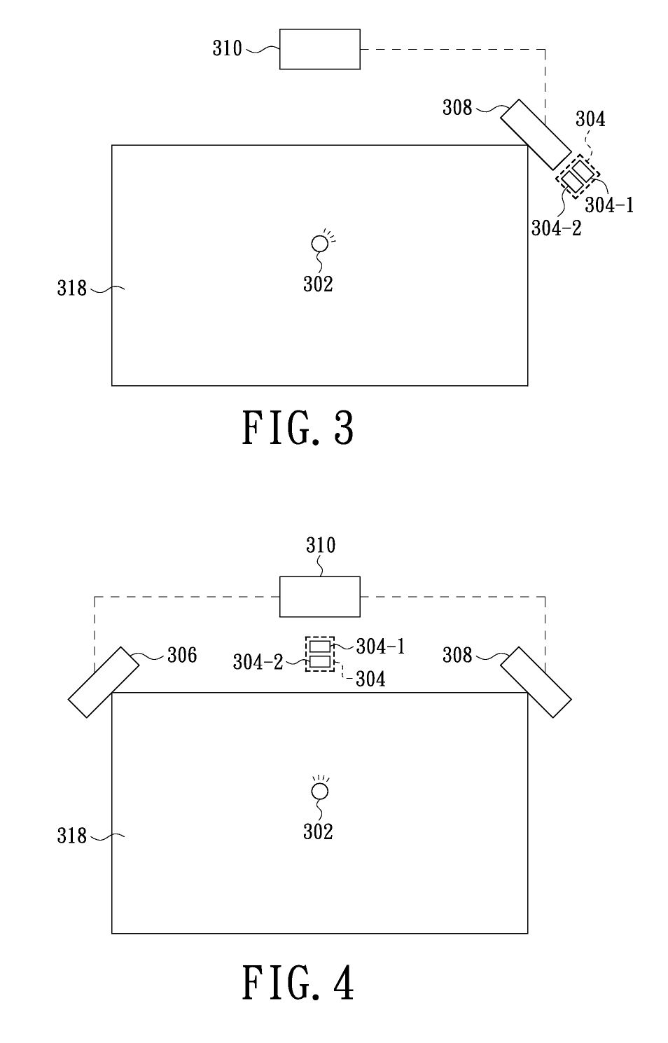

FIG. 3 is a top view of the optical touch control apparatus in accordance with a preferred embodiment of the present invention. Referring to FIG. 3, the optical touch control apparatus includes a light source supply module 304, an image sensing apparatus 308 and a processing circuit 310. The light source supply module 304 is used for supplying a first light source to illuminate an object 302 located on a plane 318. In the embodiment, the plane 318 is shaped as a parallelogram that is perfectly shaped in rectangle. The size of the plane 318 can be determined in an internal software of the processing circuit 310, or a range of the size of the plane 318 is defined by objects disposed at the four corners of the plane 318. In the embodiment, the light source supply module 304 includes a laser light source 304-1 and an optical element 304-2. The laser light source 304-1 is used for providing a first line light source. The optical element 304-2 is used for converting the above first line light source into the first light source for illuminating the plane 318. In the embodiment, the optical element 304-2 can be a cylindrical lens or an MEMS scanning mirror. The cylindrical lens is used for converting the line light source generated by the laser light source 304-1 into a plane light source, so that the plane light source can be used as the first light source for illuminating the plane 318. The MEMS scanning mirror is used for changing the light direction of the line light source generated by the laser light source 304-1 to form the first light source, so as to scan the plane 318 through the first light source. The light of the first light source goes forwards the plane 318, so that the entire plane 318 is in an illuminated area of the first light source.

The image sensing apparatus 308 is disposed at one corner of the plane 318, and is used for detecting the light of the first light source reflected by the surface of the object 302 to acquire an image. When the object 302 is illuminated by the first light source, a side of the object 302 towards the first light source may reflect the light, thus, the processing circuit 310 can receive the image sensed by the image sensing apparatus 308 and then calculate the position of the object 302 related to the plane 318 according to the image features of the light of the first light source reflected by the surface of the object 302 in the acquired image and the imaging position of the object 302 on the image sensing apparatus 308. The image features comprise at least one of the brightness and the imaging size of the object image.

As stated above, it should be understood that, the optical touch control apparatus can calculate the position of the object 302 without any background light source. Besides this, the optical touch control apparatus doesn't need any reflector, light emitting element or light guide element for providing a background light source, thus, misjudging the position of the object because of institution's flatness or bending can be avoided.

### A Second Embodiment

FIG. 4 is a top view of the optical touch control apparatus in accordance with another preferred embodiment of the present invention. Referring to FIG. 4, compared with the optical touch control apparatus in the first embodiment, the optical touch control apparatus in the second embodiment further includes an image sensing apparatus 306. The image sensing apparatus 306 is disposed at another corner of the plane 318, and is used for detecting the light of the first light source generated by the light source supply module 304 and reflected by the surface of the object 302 to acquire another image. In addition, the processing circuit 310 receives the image sensed by the image sensing apparatus 308, and further receives the image sensed by the image sensing apparatus 306, and calculates the position of the object 302 related to the plane 318 according to the image features of the light of the first light source reflected by the surface of the object in the acquired two images and the imaging positions of the object on the two image sensing apparatuses. It needs to be pointed that, in a preferable design, the light source supply module 304 can be disposed between the image sensing apparatuses 306 and 308, so long as the light direction of the first light source generated by the light source supply module 304 forwards the plane 318.

### A Third Embodiment

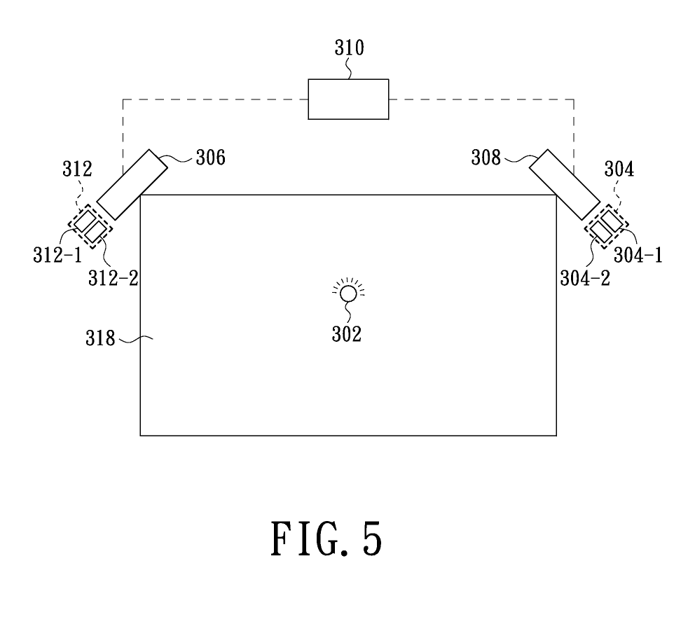

FIG. 5 is a top view of the optical touch control apparatus in accordance with a third preferred embodiment of the present invention. Referring to FIG. 5, compared with the optical touch control apparatus in the second embodiment, the optical touch control apparatus in the third embodiment includes two light source supply modules respectively labeled with 304 and 312. The light source supply module 304 and 312 are respectively used for supplying a first light source and a second light source, and the light of the first light source and the second light source goes forwards the plane 318. Besides this, each of the image sensing apparatuses is used cooperating with a light source supply module.

Similar to the light source supply module 304, the light source supply module 312 includes a laser light source 312-1 and an optical element 312-2. The laser light source 312-1 is used for providing a second line light source, and the optical element 312-2 is used for converting the second line light source into the second light source for illuminating the plane 318. Similar to the optical element 304-2, the optical element 312-2 includes a cylindrical lens or a MEMS scanning mirror, the cylindrical lens is used for converting the second line light source into a plane light source as the second light source for illuminating the plane 318, the MEMS scanning mirror is used for changing the light direction of the second line light source to form the second light source, so as to scan the plane 318 through the second light source.

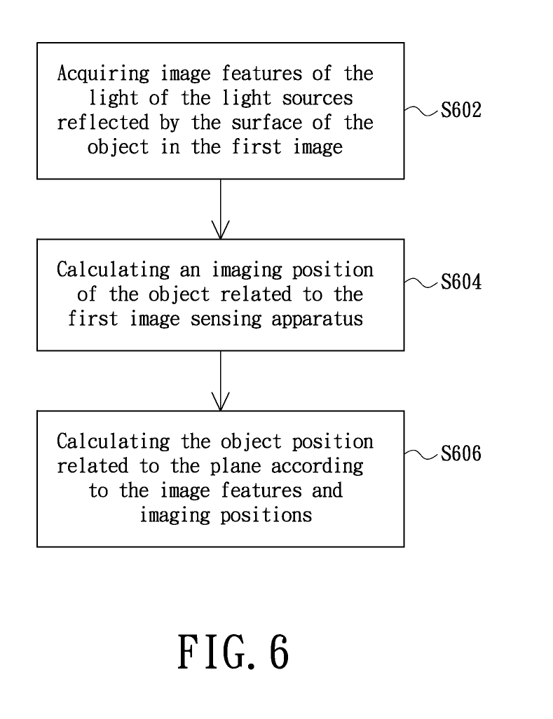

In accordance with teachings of the above embodiments, some basic processing steps of a touch sensing method can be concluded as shown in FIG. 6. FIG. 6 is a processing diagram of the touch sensing method in accordance with a preferred embodiment of the present invention. Referring to FIG. 6, the touch sensing method is used for an optical touch control apparatus, wherein the optical touch control apparatus includes a light source supply module and a first image sensing apparatus. The light source supply module is used for supplying a light source to illuminate an object located on a plane. The first image sensing apparatus is disposed at a first corner of the plane, and is used for detecting the light of the light source reflected by the surface of the object to acquire a first image. The method comprising following steps of: acquiring image features of the light of a light source reflected by the surface of the object in the first image (step S602); calculating an imaging position of the object on the first image sensing apparatus (step S604); and calculating the object position related to the plane according to the above image features and the imaging position (step S606).

In another embodiment, if the optical touch control apparatus further includes a second image sensing apparatus disposed at a second corner of the plane. The second image sensing apparatus is used for detecting the light of the above light source reflected by the surface of the object to acquire a second image. The method further comprises steps of: acquiring image features of the light of the light source reflected by the surface of the object in the second image; calculating an imaging position of the object on the second image sensing apparatus; and calculating the object position related to the plane according to the above image features and the imaging position of the first acquired image and the above images features and the imaging position of the second acquired image.

As stated above, the present invention uses a light source supply module, an image sensing apparatus and a processing circuit in an optical touch control apparatus. The light source supply module is used for supplying a light source to illuminate an object located on a plane. The image sensing apparatus is disposed at one corner of the plane, and is used for detecting the light of the light source reflected by the surface of the object to acquire an image. The processing circuit receives the image and calculates the object position related to the plane according to the image features of the object image in the acquired image and the imaging position of the object on the image sensing apparatus. Thus, the optical touch control apparatus calculates the object position related to the plane only according to the reflective brightness of the object and the imaging position of the object on the image sensing apparatus, but without use of any background light source. Besides this, the present invention doesn't need any reflector, light emitting element or light guide element for providing a background light source, thus, misjudging the position of the object because of institution's flatness or bending can be avoided.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An optical touch control apparatus, comprising:
a first light source supply module used for supplying a first light source for illuminating an object on a plane;
a first image sensing apparatus disposed at a first corner of the plane, for detecting the light of the first light source reflected by a surface of the object to acquire a first image; and
a processing circuit receiving the first image and calculating the object position related to the plane according to the image features of the light of the first light source reflected by the surface of the object in the acquired first image and the imaging position of the object on the first image sensing apparatus.

2. The optical touch control apparatus as claimed in claim 1, wherein the image features comprise at least one of the brightness and the imaging size of the object image.

3. The optical touch control apparatus as claimed in claim 1, wherein the first light source supply module comprises:
a laser light source used for providing a line light source, and
an optical element used for converting the line light source into the first light source for illuminating the plane.

4. The optical touch control apparatus as claimed in claim 3, wherein the optical element comprises a cylindrical lens or an MEMS scanning mirror, the cylindrical lens is used for converting the line light source into a plane light source as the first light source for illuminating the plane, the MEMS scanning mirror is used for changing the light direction of the line light source to form the first light source, so as to scan the plane through the first light source.

5. The optical touch control apparatus as claimed in claim 1, further comprising a second image sensing apparatus disposed at a second corner of the plane, the second image sensing apparatus being used for detecting the light of above light source reflected by the surface of the object to acquire a second image, the processing circuit further receiving the second image and calculating the object position related to the plane according to the image features of the light of the first light source reflected by the surface of the object in the acquired first image and the imaging position of the object on the first image sensing apparatus and, the image features of the light of the first light source reflected by the surface of the object in the second image and the imaging position of the object on the second image sensing apparatus.

6. The optical touch control apparatus as claimed in claim 5, wherein the first light source supply module comprises:
a laser light source used for providing a line light source; and
an optical element used for converting the line light source into the first light source for illuminating the plane.

7. The optical touch control apparatus as claimed in claim 6, wherein the optical element comprises a cylindrical lens or an MEMS scanning mirror, the cylindrical lens is used for converting the line light source into a plane light source as the first light source for illuminating the plane, the MEMS scanning mirror is used for changing the light direction of the line light source to form the first light source, so as to scan the plane through the first light source.

8. The optical touch control apparatus as claimed in claim 5, further comprising a second light source supply module used for supplying a second light source to illuminating the object on the plane.

9. The optical touch control apparatus as claimed in claim 8, wherein the first light source supply module includes a first laser light source and a first optical element, the first laser light source is used for providing a first line light source, the first optical element is used for converting the first line light source into the first light source for illuminating the plane; the second light source supply module includes a second laser light source and a second optical element, the second laser light source is used for providing a second line light source, the second optical element is used for converting the second line light source into the second light source for illuminating the plane.

10. The optical touch control apparatus as claimed in claim 9, wherein the first optical element comprises a first cylindrical lens or a first MEMS scanning mirror, the first cylindrical lens is used for converting the first line light source into a first plane light source as the first light source for illuminating the plane, the first MEMS scanning mirror is used for changing the light direction of the first line light source to form the first light source, so as to scan the plane through the first light source; the second optical element comprises a second cylindrical lens or a second MEMS scanning mirror, the second cylindrical lens is used for converting the second line light source into a second plane light source as the second light source for illuminating the plane, the second MEMS scanning mirror is used for changing the light direction of the second line light source to form the second light source, so as to scan the plane through the second light source.

11. The optical touch control apparatus as claimed in claim 8, wherein the first light source supply module is disposed at the first corner, and the second light source supply module is disposed at the second corner.

12. The optical touch control apparatus as claimed in claim 1, wherein the plane is shaped as a parallelogram.

13. A touch sensing method used for an optical touch control apparatus, the optical touch control apparatus comprising a light source supply module and a first image sensing apparatus, the light source supply module being used for supplying a light source to illuminate an object located on a plane, the first image sensing apparatus being disposed at a first corner of the plane and used for detecting the light of the light source reflected by a surface of the object to acquire a first image; the method comprising steps of:
acquiring image features of the light of the light source reflected by the surface of the object in the first image;
calculating an imaging position of the object on the first image sensing apparatus; and
calculating the object position related to the plane according to the image features and the imaging position.

14. The touch sensing method as claimed in claim 13, wherein the image features comprise at least one of the brightness and the imaging size of the object image.

15. The touch sensing method as claimed in claim 13, wherein the optical touch control apparatus further includes a second image sensing apparatus disposed at a second corner of the plane, and the second image sensing apparatus is used for detecting the light of the light source reflected by the surface of the object to acquire a second image; the touch sensing method further comprising:
acquiring image features of the light of the light source reflected by the surface of the object in the second image;
calculating an imaging position of the object on the second image sensing apparatus; and
calculating the object position related to the plane according to above image features and the imaging position of the first image and the imaging position of the second image.
